(19) United States
(12) Patent Application Publication
(10) Pub. No.: US 2003/0004788 A1
(43) Pub. Date: Jan. 2, 2003

(54) Targeted questionnaire system for healthcare

(76) Inventors: Catherine M. Edmundson, Dunlap, IL (US); Richard C. Luetkemeyer, Peoria, IL (US); Djuana Montgomery, Peoria, IL (US); Michael Taylor, Morton, IL (US)

Correspondence Address: Finnegan, Henderson, Farabow,, Garrett & Dunner, L.L.P., 1300 I Street, N.W., washington, DC, 20005-3315, US

(21) Appl. No.: 10/164,016

(22) Filed: Jun. 7, 2002

Related U.S. Application Data
(60) Provisional application No. 60/302,337, filed on Jun. 29, 2001.

(51) Int. Cl. G06F 17/60

(52) U.S. Cl. 705/10

(57) ABSTRACT

A method for using targeted questionnaires to improve the health of a covered population is disclosed. In operation, the system and method builds a set of targeted questions associated with a health risk assessment strategy, devises potential tailored feedback based at least in part upon the potential answers to the targeted questions, administers the targeted questions to a target population, and provides actual tailored feedback to the target population.

### RELATED CASES

This application claims priority from the provisional application, entitled “Healthy Balance Program,” serial No. 302,337/60, filed on Jun. 29, 2001.

### TECHNICAL FIELD

The invention relates to the field of healthcare, and more specifically, a system for and method of using targeted questions directed to a covered population and responses to those questions to monitor and improve the health of the covered population.

### BACKGROUND

Healthcare costs have been rising at a staggering rate over the past two decades. In response, individuals, businesses, and insurance carriers have been seeking ways to lower healthcare costs. For instance, the rise in the use of health maintenance organizations (HMO's) is one attempt to gain control of the costs of healthcare. While controlling costs is one way to reduce the costs of healthcare, the only way to reduce the costs of healthcare in the long run is to focus on the “demand side.”

One of the best ways to reduce the costs of healthcare is to reduce the demand for healthcare by maintaining and improving the health of members of a covered population of people. Not only does this reduce the costs of health care for the insurer and those paying premiums, but it also increases the quality of life for those whose health is improved. One goal of a demand side program may be to increase the life expectancy and quality of life of population members by helping individuals gain the knowledge, motivation, and opportunities they need to make informed decisions about their health.

A comprehensive health promotion/disease prevention program is thus helpful to reduce demand side costs. Accurate information regarding the covered population is helpful in establishing an effective health promotion/disease prevention program.

Preventable illness makes up approximately 70 percent of the burden of illness and its associated costs. Preventable causes of illness, led by cigarette smoking, lack of exercise and poor diet, represent eight of the nine leading causes of death in the U.S., accounting for 980,000 deaths per year. Self efficacy, the confidence gained by accepting accountability for one's lifestyle choices, is helpful for subsequent changes in health behaviors. Researchers and experts have shown that appropriate health care utilization is linked to the presence or absence of personal self-efficacy and to the availability of well-presented information. However, present questionnaire systems do not acquire the desired information.

There are existing systems that provide a system of questionnaires directed at individual participants of the covered population. Such programs operate by using a finite set of questionnaires broken up into channeling questionnaires and serial questionnaires. The channeling questionnaires are used to determine whether individual members of the population fall into a high risk or low risk profile. Members who are determined to be in the low risk profile receive the same repeated questionnaire every six months. Members in the high risk profile receive one or more of a finite number of high risk questionnaires every three months. For instance, high risk questionnaires, or modules, are available on weight management, smoking, asthma, arthritis, as well as additional areas. While these programs may be effective in developing questionnaires and feedback, they are not truly targeted because they fails to modify the questionnaire based on the answers to previous questionnaires. In other words, the same individual, having certain characteristics, will receive the same questionnaire repeatedly, regardless of his answers on previous questionnaires. This leads to poor participation and repeated feedback. In addition, the such programs are unable to assess the staging of the individual, or the individuals inclination toward adopting behavioral changes.

The present invention is directed to overcoming the one or more problems or disadvantages associated with the prior art.

### SUMMARY OF THE INVENTION

In accordance with an aspect of the present invention, a method for using targeted questionnaires to improve the health of a covered population is disclosed. In operation, the method builds a set of targeted questions associated with a health risk assessment strategy, devises potential tailored feedback based at least in part upon the potential answers to the targeted questions, administers the targeted questions to a target population, and provides actual tailored feedback to the target population.

In accordance with another aspect of the present invention, a machine-readable storage medium having stored thereon machine executable instructions is disclosed. The execution of the instructions is adapted to implement a method for using targeted questionnaires to improve the health of a covered population. The method includes building a set of targeted questions associated with a health risk assessment strategy. Further, the method includes devising potential tailored feedback based at least in part upon the potential answers to the targeted questions. The method also includes administering the targeted questions to a target population and providing actual tailored feedback to the target population.

In accordance with another aspect of the present invention, a system for using targeted questionnaires to improve the health of a covered population is disclosed. The system includes a microprocessor and memory coupled to the microprocessor. The microprocessor is operable to build a set of targeted questions associated with a health risk assessment strategy. Further, the microprocessor can devise potential tailored feedback based at least in part upon the potential answers to the targeted questions. Also, the microprocessor is operable to administer the targeted questions to a target population and to provide actual tailored feedback to the target population.

The foregoing summarizes only a few aspects of the invention and is not intended to be reflective of the full scope of the invention as claimed. Additional features and advantages of the invention are set forth in the following description, may be apparent from the description, or may be learned by practicing the invention. Moreover, both the foregoing summary and the following detailed description are exemplary and explanatory and are intended to provide further explanation of the invention as claimed.

### BRIEF DESCRIPTION OF THE DRAWINGS

The accompanying drawings, which are incorporated in and constitute a part of this specification, illustrate one embodiment of the invention and together with the description, serve to explain the principles of the invention.

FIG. 1 is a flow chart illustrating one embodiment of the targeted questionnaire and feedback process for an exemplary embodiment of the present invention.

FIG. 2 is a flow chart illustrating one embodiment of the building of the HRAs in an exemplary embodiment of the present invention.

FIG. 3 is a flow chart illustrating one embodiment of the process of administering targeted HRAs in an exemplary embodiment of the present invention.

FIG. 4 is a flow chart illustrating one embodiment of the entry of HRA questionnaire results and generation of feedback of an exemplary embodiment of the present invention.

FIG. 5 illustrates a system environment in which the features and principles of the present invention may be implemented

### DETAILED DESCRIPTION

Reference will now be made in detail to the present exemplary embodiments of the invention, examples of which are illustrated in the accompanying drawings. Wherever possible, the same reference numbers will be used throughout the drawings to refer to the same or like parts.

Healthcare programs may be managed in part, by responding to the health characteristics of the population associated with the healthcare program. Health related information associated with the population needs to be gathered in order to determine the health characteristics of the population. This health related information may be gathered through multiple questionnaires disseminated to the population. That is, as discussed below, there is an initial questionnaire disseminated to the population to establish some preliminary health related information associated with the population. Then, based on the responses to the initial questionnaire, one or more targeted questionnaires is established and disseminated to an associated target population. The targeted population may be a portion, or subset of the entire population.

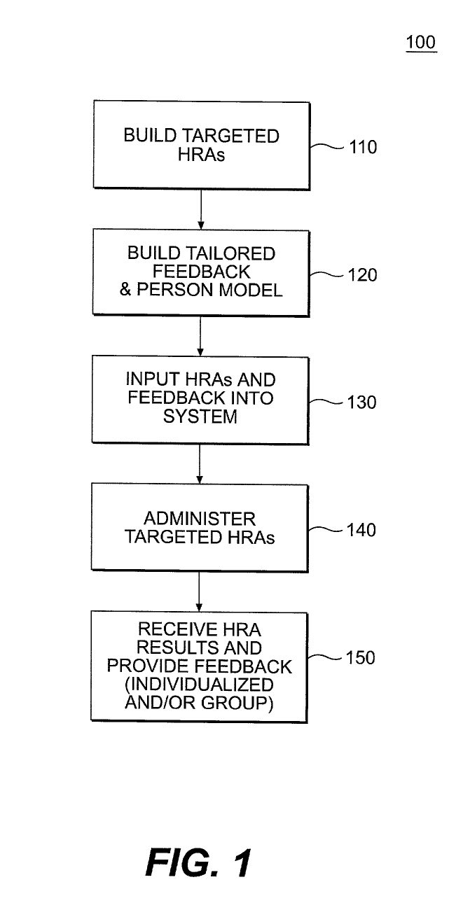

FIG. 1 illustrates a flow chart of the targeted questionnaire and feedback process for an exemplary embodiment of the present invention. Targeted questionnaire and feedback process (TQF process) 100 begins at stage 110 with the building of Health Risk Assessments (“HRAs”). In the exemplary embodiment, HRAs are developed to refine and/or define a targeted HRA strategy, define questions, priorities, frequencies, timing, and the targeted population. At stage 120, medical expertise may be employed to develop the appropriate feedback to HRA results. At stage 130, the HRAs developed in stage 110 and the feedback developed in stage 120 may be entered into a computer system or manually compiled, so that, at stage 140, targeted HRA packages may be generated for individual participants in the population based on the targeted population defined in stage 110. Further, at stage 140, the HRA packages are administered to the targeted population. At stage 150, the results of the HRA packages are entered into the computer system which generates individual feedback based on the results.

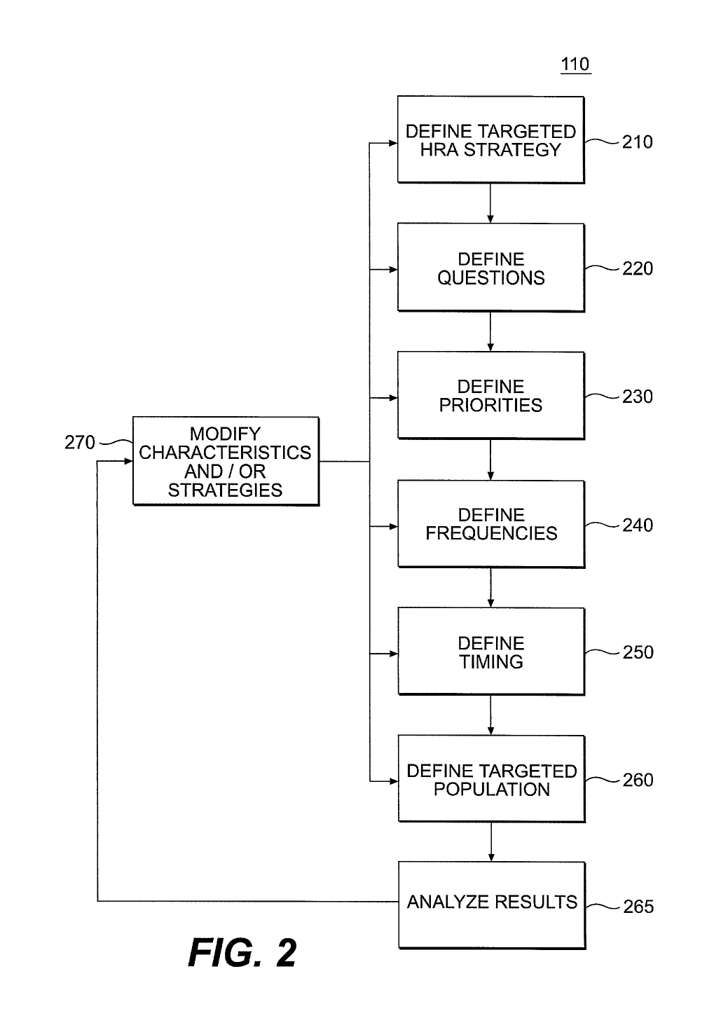

FIG. 2 illustrates a flow chart of the building of the HRAs of stage 110 in an exemplary embodiment of the present invention. HRAs are developed to refine and/or define the targeted HRA strategy, define questions, priorities, frequencies, timing, and the targeted population. At stage 210, the targeted HRA strategy is developed. In the exemplary embodiment of the invention, this is performed by medical experts, e.g. doctors, nurses, etc., who define a medical target for improvement among the covered population. However, other clinical personnel or management may take part in the process. Indeed, the targeted HRA strategy could even be performed automatically based on analysis of health data of the covered population. Smoking cessation is one possible targeted HRA strategy that may be defined at stage 210. This is one of many particular strategies that could be defined by physicians, management, clinical personnel, or suggested by automated computer analysis well known to those skilled in the art.

At stage 220, targeted questions are developed based on the specific targeted strategy defined in stage 210. The questions developed are up to the expertise of the physicians or clinicians involved, but they generally lie in one of four categories. Targeted questions are those questions administered to a member of the population based at least in part upon results from previously administered questionnaires to that member, such as the initial questionnaire.

One category of a targeted question is an applicability question. An applicability question establishes whether further questions would be appropriate from the respondent of the questionnaire. For instance, a targeted smoking questionnaire may ask, “Do you currently smoke cigarettes?” This would alleviate the need for the respondent to answer further questions about their smoking habits. While the questionnaire would generally not go to a non-smoker, the relevant personnel data may be out of date or the person may have recently quit smoking. The second category of questions are in regard to contraindications. These questions relate to whether a particular course of treatment or feedback suggestions are appropriate based on the respondents' medical history. The third category of questions is about barriers. Questions may be posed to determine what barriers to treatment might lie in the respondents' attitudes to treatment. A fourth category of questions relates to staging, or what mental stage a respondent is at in terms of his readiness to proceed with treatment, i.e., is the person willing to change their lifestyle. Other categories and types of questions may be used.

In one embodiment, at stage 230, priorities may be assigned to the strategy developed at stage 210. HRA strategies may be prioritized so that when targeted questionnaires are generated at stage 140, the questions relating to a particular strategy will appear in their order of priority. Also, limits may be imposed on the length of a questionnaire, and those HRA strategies of lower priority may have to be removed from the generated targeted HRA questionnaire.

At stage 240, frequencies may be defined for how often the questions associated with this HRA strategy should be repeated. In the exemplary embodiment of the present invention, HRA strategy questions are assigned a frequency with which they should be asked. This reduces repetition and permits lower priority HRA strategy questions the opportunity to be posed when they might be otherwise blocked by higher HRA strategy questions. In addition, the frequency may be modified based dynamically on future responses or targeted feedback.

At stage 250, the timing of questions may be established. Similar to the frequency concept of stage 240, the timing concept might be used to block questions from being presented at certain times of the year or to trigger an HRA strategy to be presented. For instance, weight associated HRA strategy questions might be disabled over the Christmas holiday season when weight loss and treatment strategies are less successful. By the same token, post New Years Day might trigger weight associated HRA strategies.

At stage 260, the target population for the HRA strategy developed at stage 210 is defined. A Targeted HRA Person Model may be used to define the target population. The target population is the result of a match of HRA strategies with a database of information about the covered population to determine which members of the covered population receive the HRA strategy questions (the target population). Established target population characteristics are used in a query to the database to determine the appropriate target population. For instance, for an HRA strategy of an aspirin regimen for those members of the covered population having cardiovascular risk, the target population may be defined as males over the age of 50 or females over the age of 55 who have an additional cardiovascular risk. Additional factors that may be used to establish the target population include, but are not limited to, the personnel database, self-reported information from previous questionnaires, or medical and drug records. A single HRA strategy may have multiple targeted populations, as illustrated above for the aspirin strategy. Different HRA strategies may well have different target populations established. A given target population, of which there are an almost infinite number in a set of covered population, may find themselves the target of multiple HRA strategies.

An HRA strategy may be targeted at one or more health risks. For instance, a health risk may be cardiovascular risk. The targeted questionnaire may be used to establish who is at risk for cardiovascular problems in the targeted population. A profile may be used to indicate which members of the target population would respond to a particular HRA strategy, e.g. aspirin regime.

At stage 265, the results are analyzed. In addition, once a targeted population is identified, the creator of the Targeted HRA Person Model may run a simulation of the model against the database of the covered population to determine how many people match the model. This is useful, for instance, when budgetary constraints may enable the feedback that will have the largest success rate for the identified health risk, and that will impact the most people, to be established. Or, fixed startup costs of an HRA strategy may require that a minimum number of people participate to justify the costs of generating and implementing the HRA strategy. Running a simulation allows the Person Model to be tuned to increase or decrease the number of covered population who would be included in the target population.

Feedback and modification of the targeted HRA process is useful in making continuous improvement to the process. Where prior art “targeted” questionnaire systems not only fail to truly target a population, they also fail to modify themselves based on the successes or failures of an overall HRA strategy 110. At stage 270, the system, either manually or through an automated process, may modify one or more of the characteristics defined in stages 210 through 260. TQF process 100 may yield a large database of results of HRA targeted questionnaires and may have access to the feedback provided to the target population, as well as the target population's medical records. Examination of the results of the TQF process may provide information that would suggest, for instance, the enlargement of the targeted population, so that an HRA strategy may possibly benefit additional members of the covered population.

Returning to FIG. 1, at stage 120 the tailored feedback is established. In the exemplary embodiment of the present invention, this is established by defining a set of appropriate responses (feedback) to self-reported answers of one or more questions. These Tailored feedback—Person Models may define a set of appropriate responses for each person model who answered the targeted questionnaire. The Tailored feedback—Person Model is based on the answers to the questions of the targeted questionnaire and the characteristics of the person completing the questionnaire.

For instance, a targeted smoking questionnaire might have one tailored feedback designed for those over age 60 who smoke, have tried multiple times to quit, and are contemplating quitting in the next month, while a second tailored feedback is intended for those over age 60 who smoke and have no interest in quitting smoking. The feedback may be a letter, an implementation strategy, a follow-up questionnaire, etc. The feedback may be illustrated with regard to a preset letter for each Tailored feedback—Person Model. However, the Tailored feedback—Person Model, may be defined such that individual paragraphs, or even sentences, are placed into a form letter based on the model. Through the use of a paragraph, instead of a letter-based model, greater flexibility is given to generate a single feedback letter when a targeted questionnaire may be composed of multiple HRA strategy questions. Thus, an individual who is a member of two different targeted populations, for instance colorectal cancer and smoking, and who receives both sets of HRA strategy questions may receive a single feedback letter comprising all feedback, instead of two feedback letters.

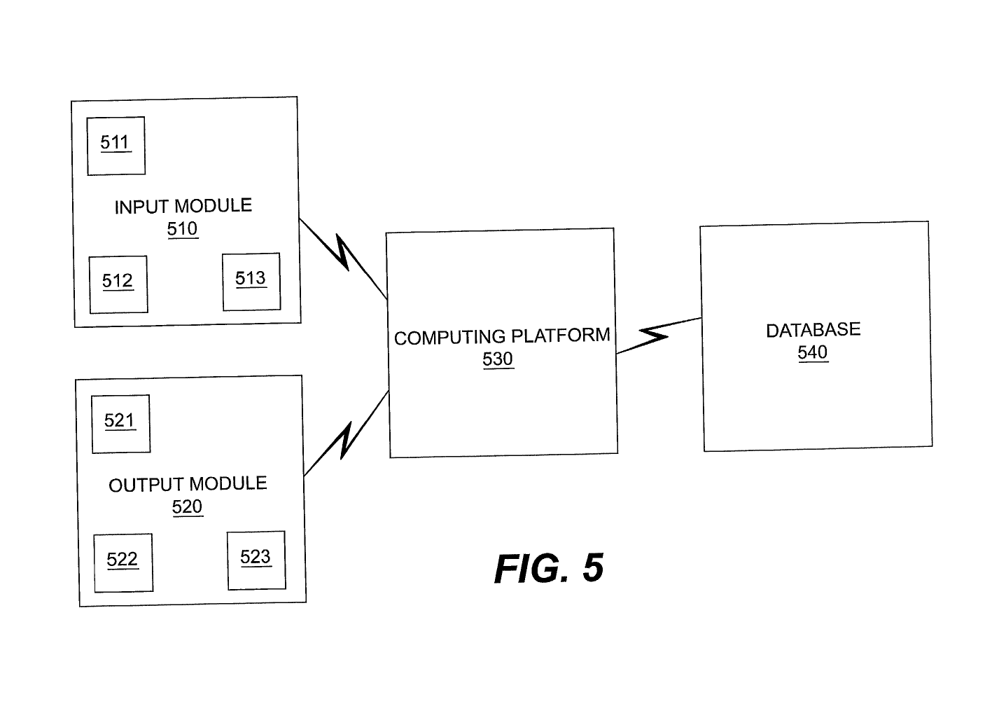

At stage 130, the targeted HRA questions, Targeted HRA—Person Models, and Tailored feedback Person Models may be input into the computer system database. The computing platform 530, more fully shown in FIG. 5 and its accompanying description, may include a database 540 describing the covered population and a database having health records, including medical and pharmaceutical records for the covered population.

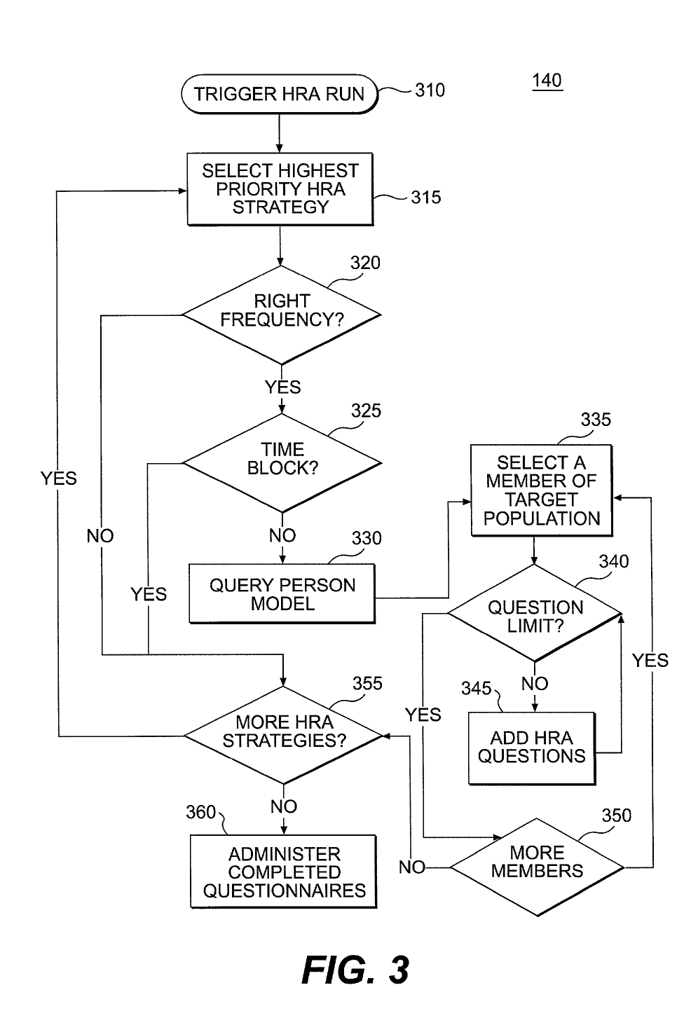

At stage 140, the targeted HRAs are administered. FIG. 3 is a flow chart illustrating the process of administering targeted HRAs in an exemplary embodiment of the present invention. At stage 310, a trigger is generated that initiates the administration process 140. The trigger may be manually generated or may be automatically generated based on time or calendar information ore previously acquired information. For instance, the system may activate a trigger every fiscal quarter. Once the trigger is activated, at stage 315, the computing platform 530 searches its database of HRA strategies and determines the highest priority strategy that has not been utilized during the current process 140. At stage 320, the frequency is checked to determine if the current date is appropriate for administering the selected HRA strategy or if the current time is too close in frequency to the last time the HRA strategy was administered. If the frequency is too soon, processing proceeds to stage 355 where processing of other HRA strategies may proceed.

If the frequency is appropriate, flow proceeds to stage 325 where the time constraints are checked to see if the current date is a time blocked date for the selected HRA strategy. If the date is blocked for the current strategy, flow continues to stage 355; otherwise, flow proceeds to stage 330.

At stage 330, the Targeted HRA Person Model of the selected HRA strategy is used to generate a query of the covered population database. This query yields a subset of the covered population, which is the targeted population for this HRA strategy. At stage 335, a member of the targeted population is selected. At stage 340, for the selected member of the targeted population, a check may be performed of the length of the targeted HRA questionnaire that has been generated thus far. If a maximum length has been selected for the questionnaire and the length has been exceeded, flow continues to stage 350 where further members of the target population may be processed. If the maximum length has not been exceeded, and will not be exceeded by the addition of questions, processing proceeds to stage 345 where the targeted questions from the currently selected HRA strategy are added to the individual's questionnaire. Flow proceeds to stage 350 where additional members of the targeted population will be processed through stages 335 through 345. Once all members of a targeted population have been processed, flow proceeds to stage 355.

At stage 355, if further HRA strategies are in the database of HRA Strategies, then flow proceeds to stage 315. If no more strategies are in the system, flow proceeds to state 360 where the targeted questionnaires are administered. For each member of each targeted population selected by the HRA strategies, the associated questionnaire generated in steps 335 through 345 is provided to the member. In the exemplary embodiment of the invention, the questionnaires may be printed by computer platform 510 and mailed to members, may be sent by email to the members, or may be accessed as an HTML form by the members via the Internet or corporate Intranet.

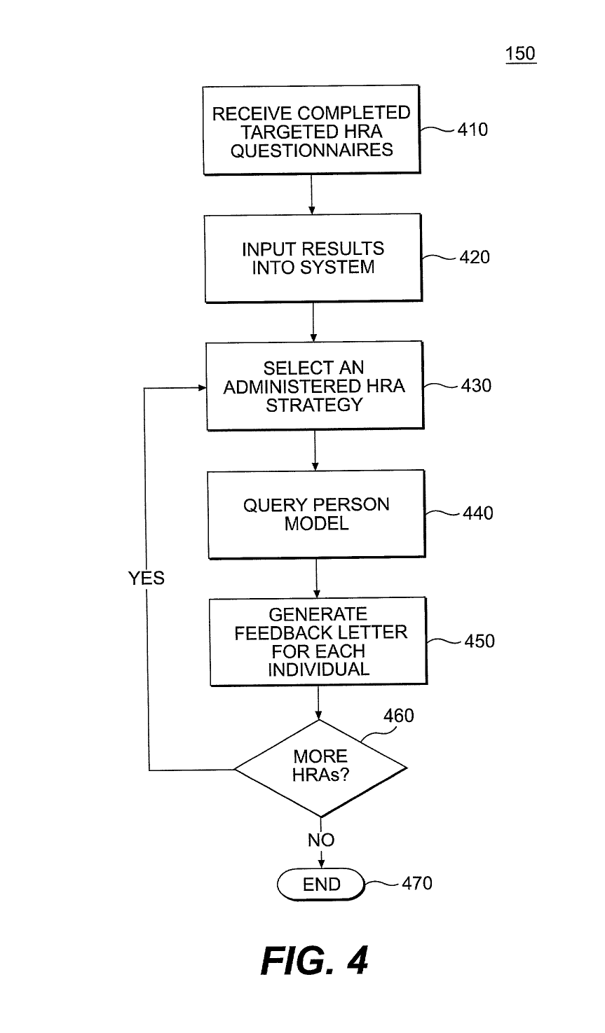

Once the questionnaires have been completed, the process continues at stage 150. FIG. 4 is a flow chart illustrating the entry of HRA questionnaire results and generation of feedback of an exemplary embodiment of the present invention. At stage 410, completed, targeted HRA questionnaires are received by the system. At stage 420, the completed questionnaires are input into the system. In the exemplary embodiment of the invention, completed questionnaires are entered either in batch form or individually. Entry may also be accomplished by computer recognition through scanned input, such as electronic form readers or handwriting recognition.

After the entry of the completed questionnaires into the system and their subsequent storage in the database, at stage 430 one of the HRA strategies that had been administered at stage 140 is selected. At stage 440, the Tailored feedback Person Model is drawn from the HRA strategy and a query is performed on the database containing the completed questionnaire and information about the associated member of the targeted group. At stage 450, the query results in the generation of at least a portion of a feedback strategy. The strategy may include a feedback letter to be mailed to the selected individual.

At stage 460, a check is done as to whether there are additional HRA strategies to be analyzed for generation of further feedback information, and, if so, processing returns to stage 430. If not, at stage 470 the process ends with the completed feedback strategy being implemented, which may include letters being delivered to the individual persons who completed the questionnaire.

In addition to the generation of feedback to enhance the lives of those involved in the programs of the disclosed invention, specific targeted, or tailored, benefits may be generated as a result of analysis of the questionnaires. For instance, in the case of a colorectal screening HRA strategy, further medical benefits may be targeted based on the results strategy.

Also, the results of the analysis of the targeted questionnaire may result in the automatic generation of insurance pre-authorizations for treatment. In this way, time and money are conserved by leveraging the information gathered by the process. Also, the lifestyle of the individual member is further enhanced by the simplification of seeking and receiving medical treatment.

A hardware platform capable of implementing the system is now illustrated. By way of a non-limiting example, FIG. 5 illustrates a system environment in which the features and principles of the present invention may be implemented. As illustrated in the block diagram of FIG. 5, a system environment consistent with an embodiment of the present invention includes an input module 510, an output module 520, a computing platform 530, and a database 540. Computing platform 530 is adapted to include the necessary functionality and computing capabilities to implement HRA strategies input through input module 510 and access, read and write to database 540. The results of analyzing the data are provided as output from computing platform 530 to output module 520 for printed display, viewing, or further communication to other system devices. Such output may include, for example, one or more targeted questionnaires or feedback letters. Output from computing platform 530 can also be provided to database 540, which may be utilized as a persistent storage device for storing, for example, questionnaire responses.

In the embodiment of FIG. 5, computing platform 530 may comprise a PC or mainframe computer for performing various functions and operations of the invention. Computing platform 530 may be implemented, for example, by a general purpose computer selectively activated or reconfigured by a computer program stored in the computer, or may be a specially constructed computing platform for carrying-out the features and operations of the present invention. Computing platform 530 may also be implemented or provided with a wide variety of components or subsystems including, for example, one or more of the following: one or more central processing units, a co-processor, memory, registers, and other data processing devices and subsystems. Computing platform 530 also communicates or transfers HRA strategies, questionnaires and feedback to and from input module 510 and output module 520 through the use of direct connections or communication links, as illustrated in FIG. 5. In the exemplary embodiment of the invention, a firewall prevents access to the platform by unpermitted outside sources.

Alternatively, communication between computing platform 530 and modules 510, 520 can be achieved through the use of a network architecture (not shown). In the alternative embodiment (not shown), the network architecture may comprise, alone or in any suitable combination, a telephone-based network (such as a PBX or POTS), a local area network (LAN), a wide area network (WAN), a dedicated intranet, and/or the Internet. Further, it may comprise any suitable combination of wired and/or wireless components and systems. By using dedicated communication links or a shared network architecture, computing platform 530 may be located in the same location or at a geographically distant location from input module 510 and/or output module 520.

Input module 510 of the system environment shown in FIG. 5 may be implemented with a wide variety of devices to receive and/or provide the data as input to computing platform 530. As illustrated in FIG. 5, input module 510 includes an input device 511, a storage device 512, and/or a network 513. Input device 511 may include a keyboard, a mouse, a disk drive, video camera, magnetic card reader, or any other suitable input device for providing customer data to computing platform 530. Memory device may be implemented with various forms of memory or storage devices, such as read-only memory (ROM) devices and random access memory (RAM) devices. Storage device 512 may include a memory tape or disk drive for reading and providing customer or credit data on a storage tape or disk as input to computing platform 520. Input module 510 may also include network interface 513, as illustrated in FIG. 5, to receive data over a network (such as a LAN, WAN, intranet or the Internet) and to provide the same as input to computing platform 530. For example, network interface 513 may be connected to a public or private database over a network for the purpose of receiving information about the covered population from computing platform 530.

As illustrated in FIG. 5, output module 520 includes a display 521, a printer device 522, and/or a network interface 523 for receiving the results provided as output from computing module 520. As indicated above, the output from computing platform 530 may include one or more questionnaires or feedback letters. The output from computing platform 530 may be displayed or viewed through display 521 (such as a CRT or LCD) and printer device 522. If needed, network interface 523 may also be provided to facilitate the communication of the results from computer platform 530 over a network (such as a LAN, WAN, intranet or the Internet) to remote or distant locations for further analysis or viewing.

The foregoing description of embodiments of the invention has been presented for purposes of illustration and description. It is not exhaustive and does not limit the invention to the precise form disclosed. Modifications and variations are possible in light of the above teachings or may be acquired from practicing of the invention. For example, the described implementation includes a particular network configuration but the present invention may be implemented in a variety of data communication network environments using software, hardware, or a combination of hardware and software to provide the processing functions.

Those skilled in the art will appreciate that all or part of systems and methods consistent with the present invention may be stored on or read from other computer-readable media, such as: secondary storage devices, like hard disks, floppy disks, and CD-ROM; a carrier wave received from the Internet; or other forms of computer-readable memory, such as read-only memory (ROM) or random-access memory (RAM).

Furthermore, one skilled in the art will also realize that the processes illustrated in this description may be implemented in a variety of ways and include multiple other modules, programs, applications, scripts, processes, threads, or code sections that all functionally interrelate with each other to accomplish the individual tasks described above for each module, script, and daemon. For example, it is contemplated that these programs modules may be implemented using commercially available software tools, using custom object-oriented code written in the C++ programming language, using applets written in the Java programming language, or may be implemented as with discrete electrical components or as one or more hardwired application specific integrated circuits (ASIC) custom designed just for this purpose.

Industrial Applicability

Methods of and systems are provided for using targeted questions directed to a covered population and responses to those questions to monitor, analyze, and improve the health of the covered population. The targeted questionnaires, known as Health Risk Assessments (HRAs), are used to collect self-reported information about a person's lifestyle behaviors that can impact his or her long term health. Questions are used that are deemed appropriate for a pre-defined population of people. For example, females would not see questions asking about their prostate screening history, but they may see questions directed at pregnancy. Based on the result of these HRAs, feedback may be sent to the individuals tailored to these results. For instance, only smokers determined to be in the “preparation” phase of considering smoke-cessation would be sent feedback defined for those in “preparation of smoke cessation.” In addition, targeted benefits may be offered for those pre-determined to be at risk of future disease. For example, hemoccult self-screenings may be offered to people under the age of fifty who report having a family history of colorectal cancer.

An example of an HRA strategy will be useful in illustrating the present invention.

A demonstration program was initiated whereby members of a test group were selected to participate as covered participants in an initial test of the present invention. The medical team decided to form an HRA strategy around prophylactic aspirin therapy as an aid in delaying and possibly preventing heart attacks. Prophylactic aspirin therapy may reduce by 50% the incidence of heart attacks, which are devastating to the victim and his or her family, as well as, expensive, incurring costs of $30,000 to $50,000 in the first year of the heart attack.

The team then selected targeted questions directed at the HRA strategy of prophylactic aspirin therapy, including the following:

“1. Do you take aspirin daily or at least every other day? (Yes/No).

2. I avoid aspirin because: a) I'm allergic to aspirin; b) I'm on anticoagulant treatment; c) I have a bleeding disorder; d) I have stomach or duodenal ulcers; e) My doctor told me not to take aspirin; f) I have recurrent gout; g) It is against my personal beliefs; h) I have tried to take aspirin, but I cannot tolerate it.

3. Which of the following apply. I do not take daily aspirin because . . . a) I see no benefit; b) I don't want to depend upon medicine; c) I have difficulty swallowing pills; d) I can't remember to take them daily; e) Although I don't have ulcers, it causes me heartburn or stomach distress; f) It costs too much; g) I haven't really thought about it; h) My doctor has never told me to take it.

4. Please select the one statement which best describes your plans: Currently, in regard to taking a daily low dose aspirin . . . a) I do not plan to start; b) I plan to start in the next 30 days; c) I plan to start in 1 to 6 months; d) I plan to start in 6 to 12 months; e) I plan to start, but am uncertain when.”

The above questions illustrate the targeted questions and the targeted questionnaire used in the experiment. Question 2 is a typical contraindication question. Question 3 is a barrier question. And, Question 4 is a staging question.

Once the questions were developed, the team selected the Targeted HRA Person Model. The Targeted HRA Person Model was males over age 50 and females over age 55 with other cardiac risk factors.

The Tailored feedback Person Model was established in the form of a series of 18 potential form letters comprised of one or more form paragraphs. For instance, response letter 5 would be sent to any member of the targeted population known as a “Personal reason for not taking ASA male/female,” which is a person who answered no to question one and yes to (g) of question 2. In this way, feedback would be specific to each individual. In addition, responses would vary as the questionnaire was repeated as people changed their habits of taking aspirin.

The Targeted HRA Person Model was then run against the covered population. Of the 1600 individuals who were members of the covered population, over 400 of them met the criteria of the Targeted HRA Person Model. These 400 individuals were then administered the targeted questionnaire previously illustrated. And, appropriate feedback was generated by the Tailored feedback Person Model.

While implementation of the demonstration system was mostly by hand, this invention contemplates either a manual, semi-computerized, or full computerized implementation.

The system and method for using targeted questionnaires according the present invention finds application in the health care industry. Specifically, the system has widespread application in the insurance industry, within corporations trying to control costs, and for any group concerned with increasing the health and lifestyle of its members.

The present invention provides a way to significantly reduce costs associated with health care by providing meaningful questionnaires and feedback to individuals seeking to improve their health. By providing questionnaires targeted at individuals, which vary over time, the questionnaires are more likely to be completed, thus encouraging participation and review of the feedback received. Tailoring the feedback to the individual increases self-efficacy for enhancing lifestyle and improvement of lifestyle choices.

It will be readily apparent to those skilled in this art that various changes and modifications of an obvious nature may be made, and all such changes and modifications are considered to fall within the scope of the appended claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims and their equivalents.

What is claimed is:

1. A method of using targeted questionnaires to analyze the health of a covered population comprising:
building a set of targeted questions associated with a health risk assessment strategy;
devising potential tailored feedback based at least in part upon a potential answers to the targeted questions;
administering the targeted questions to a target population; and
providing at least one of tailored feedback and targeted benefits to the target population.

2. The method of claim 1, wherein targeted questions include questions relating to stages, said stages indicating the readiness to change of a recipient of the questionnaire.

3. The method of claim 1, wherein said question building includes defining a priority for the health risk assessment strategy.

4. The method of claim 1, wherein said question building includes defining a frequency for the health risk assessment strategy.

5. The method of claim 1, wherein said building includes defining timing for the health risk assessment strategy.

6. The method of claim 1, wherein said building includes defining a targeted health risk assessment person model for the health risk assessment strategy.

7. The method of claim 6, further including modifying the targeted population based on results of the administration of the targeted questions.

8. The method of claim 1, wherein said devising further includes basing the tailored feedback on previously stored data from each respective member.

9. The method of claim 6, wherein said administering further includes generating a target population for the health risk assessment strategy using the targeted health risk assessment person model

10. The method of claim 9, wherein said administering further includes generating a targeted questionnaire for a member of the target population including at least one targeted question associated with a health risk assessment strategy.

11. The method of claim 9, wherein said administering further includes generating a targeted questionnaire for a member of the target population including at least two targeted questions respectively associated with two health risk assessment strategies.

12. The method of claim 9, wherein said administering further includes prioritizing the order of the targeted questions on the questionnaire based on a priority associated with the health risk assessment strategies.

13. The method of claim 10, wherein said administering further includes not placing targeted questions associated with a health risk assessment strategy on the targeted questionnaire if a predefined length limit of the targeted questionnaire would be exceeded.

14. The method of claim 1, wherein said providing feedback further includes using a targeted feedback person model associated with the health risk assessment strategy to determine an appropriate feedback response to determine the tailored feedback from a selection of feedback options.

15. The method of claim 1, further including pre-authorizing health treatments based on the results obtained from the administration of the targeted questions.

16. The method of claim 1, further including providing targeted benefits based on the results obtained from the administration of the targeted questions.

17. A machine-readable storage medium having stored thereon machine executable instructions, the execution of said instructions adapted to implement a method for using targeted questionnaires to improve the health of a covered population, said method comprising:
building a set of targeted questions associated with a health risk assessment strategy;
devising potential tailored feedback based at least in part upon the potential answers to the targeted questions;
administering the targeted questions to a target population; and
providing at least one of tailored feedback and targeted benefits to the target population.

18. The machine-readable storage medium of claim 17, wherein targeted questions include questions relating to stages, said stages indicating the readiness to change of a recipient of the questionnaire.

19. The machine-readable storage medium of claim 17, wherein said building includes defining a priority for the health risk assessment strategy.

20. The machine-readable storage medium of claim 17, wherein said building includes defining a frequency for the health risk assessment strategy.

21. The machine-readable storage medium of claim 17, wherein said building includes defining timing for the health risk assessment strategy.

22. The machine-readable storage medium of claim 17, wherein said building includes defining a targeted health risk assessment person model for the health risk assessment strategy.

23. The machine-readable storage medium of claim 22, further including modifying the targeted population based on results of the administration of the targeted questions.

24. The machine-readable storage medium of claim 17, wherein said devising further includes basing the tailored feedback on previously stored data from each respective member.

25. The machine-readable storage medium of claim 22, wherein said administering further includes generating a target population for the health risk assessment strategy using the targeted health risk assessment person model.

26. The machine-readable storage medium of claim 25, wherein said administering further includes generating a targeted questionnaire for a member of the target population including at least one targeted question associated with a health risk assessment strategy.

27. The machine-readable storage medium of claim 25, wherein said administering further includes generating a targeted questionnaire for a member of the target population including at least two targeted questions respectively associated with two health risk assessment strategies.

28. The machine-readable storage medium of claim 25, wherein said administering further includes prioritizing the order of the targeted questions on the questionnaire based on a priority associated with the health risk assessment strategies.

29. The machine-readable storage medium of claim 26, wherein said administering further includes not placing targeted questions associated with a health risk assessment strategy on the targeted questionnaire if a predefined length limit of the targeted questionnaire would be exceeded.

30. The machine-readable storage medium of claim 17, wherein said providing further includes using a targeted feedback person model associated with the health risk assessment strategy to determine an appropriate feedback response to determine the tailored feedback from a selection of feedback options.

31. The machine-readable storage medium of claim 17, further including pre-authorizing health treatments based on the results obtained from the administration of the targeted questions.

32. The machine-readable storage medium of claim 17, further including providing targeted benefits based on the results obtained from the administration of the targeted questions.

33. A system for using targeted questionnaires to improve the health of a covered population comprising:
a microprocessor and memory coupled to the microprocessor, the microprocessor operable to:
build a set of targeted questions associated with a health risk assessment strategy;
devise potential tailored feedback based at least in part upon the potential answers to the targeted questions;
administer the targeted questions to a target population; and
provide actual tailored feedback to the target population.

34. The system of claim 33, wherein said system is further operable to define a targeted health risk assessment person model for the health risk assessment strategy.

35. The system of claim 34, wherein said system is further operable to modify the targeted population based on results of the administration of the targeted questions.

36. The system of claim 33, wherein said system is further operable to base the tailored feedback on previously stored data on the covered population.

37. The system of claim 34, wherein said system is further operable to generate a target population for the health risk assessment strategy using the targeted health risk assessment person model

38. The system of claim 37, wherein said system is further operable to generate a targeted questionnaire for a member of the target population including at least one targeted question associated with a health risk assessment strategy.

39. The system of claim 37, wherein said system is further operable to generate a targeted questionnaire for a member of the target population including at least two targeted questions respectively associated with two health risk assessment strategies.

40. The system of claim 37, wherein said system is further operable to prioritize the order of the targeted questions on the questionnaire based on a priority respectively associated with the health risk assessment strategies.

41. The system of claim 38, wherein said system is further operable to not placing targeted questions associated with a health risk assessment strategy on the targeted questionnaire if a predefined length limit of the targeted questionnaire would be exceeded.

42. The system of claim 33, wherein said system is further operable to use a targeted feedback person model associated with the health risk assessment strategy to determine an appropriate feedback response to determine the tailored feedback from a selection of feedback options.

43. The system of claim 33, wherein said system is further operable to pre-authorize health treatments based on the results obtained from the administration of the targeted questions.

44. The system of claim 33, wherein said system is further operable to provide targeted benefits based on the results obtained from the administration of the targeted questions.

45. A method for using targeted questionnaires to improve the health of a covered population comprising:
building a set of targeted questions associated with a health risk assessment strategy, including defining a targeted health risk assessment person model for the health risk assessment strategy;
devising tailored feedback based at least in part upon the potential answers to the targeted questions and previously stored data on the covered population;
administering the targeted questions to a target population, including:
using the targeted health risk assessment person model to generate a listing of target population from the covered population, and
generating targeted questionnaires for each of the members of the target population; and
providing tailored feedback to the target population.

46. A method for using targeted questionnaires to improve the health of a covered population comprising:
building a set of targeted questions associated with a health risk assessment strategy, including defining a targeted health risk assessment person model for the health risk assessment strategy;
simulating the generation of a listing of a target population using the targeted health risk assessment person model; and
generating a targeted questionnaire in response to said target population and said targeted questioning.

47. The method of claim 46, further comprising modifying the targeted health risk assessment person model based on the results of the simulation.

48. A method for using targeted questionnaires to improve the health of a covered population, comprising:
building a first set of targeted questions associated with a first health risk assessment strategy, including defining a first targeted health risk assessment person model for the first health risk assessment strategy;
building a second set of targeted questions associated with a second health risk assessment strategy, including defining a second targeted health risk assessment person model for the second health risk assessment strategy; and
administering the first and second set of targeted questions to a target population, including generating a targeted questionnaire comprised of at least the first and second set of targeted questions.

49. A method for using targeted questionnaires to improve the health of a covered population, comprising:
identifying a health risk assessment strategy;
identifying a target population associated with the health risk assessment strategy; and
developing a plurality of questionnaires directed to members of the target population to implement the health risk assessment strategy, the questionnaires individually tailored to each respective member of the target population based upon each respective member's previous responses to previous questionnaires.
